(19) United States
(12) Patent Application Publication
(10) Pub. No.: US 2026/0176499 A1
(43) Pub. Date: Jun. 25, 2026

(54) METHOD FOR PATTERNING AN ADHESIVE LAYER

(71) Applicant: Avery Dennison Corporation, Mentor, OH (US)

(72) Inventors: Rishikesh BHARADWAJ, Temple City, CA (US); Vivek PANDEY, Willoughby, OH (US); Zhouzhou ZHAO, Mentor, OH (US); Tien LY, Rosemead, CA (US)

(21) Appl. No.: 19/127,204

(22) PCT Filed: Nov. 21, 2023
(86) PCT No.: PCT/IB2023/061754

§ 371 Date: May 5, 2025

Related U.S. Application Data
(60) Provisional application No. 63/386,217, filed on Dec. 6, 2022.

(51) Int. Cl. C09J 7/21; C08J 7/04; C09J 7/25; C09J 7/29; D21H 19/20

(52) U.S. Cl. CPC C09J 7/21; C08J 7/0427; C09J 7/255; C09J 7/29; D21H 19/20; C08J 2367/02; C09J 2301/204; C09J 2301/302; C09J 2301/304; C09J 2400/283; C09J 2467/006

(57) ABSTRACT

This disclosure generally relates to patterning adhesives for use on rough substrates. More particularly, the disclosure relates to methods of patterning adhesives via a roll-to-roll process to promote super adhesion to rough substrates.

### TECHNICAL FIELD

This disclosure generally relates to patterning adhesives for use on rough substrates. More particularly, the disclosure relates to methods of patterning adhesives via a roll-to-roll process to promote super adhesion to rough substrates.

### BACKGROUND

Adhesive laminates are known in the art. Such products are provided in a variety of forms including, for example, tapes, sheets, and labels. Although satisfactory in many respects, a new class of laminates is needed which provide one or more functionalities, and which can be produced in a cost-efficient manner.

A variety of techniques are known for applying an adhesive to a face material. Methods are also known in which an adhesive is coated on a secondary material which is then combined with a face material. The adhesive layer can be continuous or discontinuous. Discontinuous adhesive layers typically include regular or uniform patterns or structures. Although such patterning may reduce the amount of adhesive used, the regular or uniform patterns or structures can have limitations, such as ungummed/uncoated edges of the label resulting in poor dispensing, flagging, poor print quality, and/or poor die cutting. Although satisfactory in many respects, a need remains for additional strategies for depositing adhesive on face materials in which particular properties and/or characteristics of the resulting structure can be maintained or improved.

### SUMMARY

Exemplary embodiments relate to a method for patterning an adhesive layer comprising: providing a liner having a first side, a second side, a first edge, and a second edge; contacting the first side of the liner with a deforming member to deform the liner at least temporarily through contact with the deforming member; and substantially simultaneously when the liner is at least temporarily deformed applying an adhesive in a manner that is substantially uniform to at least a portion of the first side of the liner but less than an entirety of the first side of the liner while the liner is temporarily deformed forming a pattern of adhesive; and whereby contact of the pattern of adhesive with a rough substrate leads to enhanced adhesion on the rough substrate with less adhesive than a continuous flood coat. This embodiment or another exemplary embodiment may provide for the adhesive to be applied in a discontinuous manner. This embodiment or another exemplary embodiment may provide for the adhesive to be applied in a continuous manner. This embodiment or another exemplary embodiment may provide for the liner is a paper derived liner with a moisture content. This embodiment or another exemplary embodiment may provide for prior to contacting, further comprising: adjusting the moisture content of the liner. This embodiment or another exemplary embodiment may provide for adjusting the moisture content by adding moisture to the liner. This embodiment or another exemplary embodiment may provide for adjusting the moisture content by removing moisture to the liner. This embodiment or another exemplary embodiment may provide for adjusting the moisture content of the liner after applying the adhesive. This embodiment or another exemplary embodiment may provide for the liner comprises PET. This embodiment or another exemplary embodiment may provide for at least a portion of the liner is siliconized. This embodiment or another exemplary embodiment may provide for laminating the liner with a facestock material. This embodiment or another exemplary embodiment may provide for the applied adhesive has a peak height in the first direction and a peak width between the first edge and second edge and wherein the ratio between the peak height to the width is between about 0.02 and about 0.05. This embodiment or another exemplary embodiment may provide for the average height is in the range of about 20 μm to about 40 μm. This embodiment or another exemplary embodiment may provide for the average width is in the range of 0.4 mm to about 2.0 mm. This embodiment or another exemplary embodiment may provide for the percentage of the first side of the liner covered by the peaks of the adhesive is between about 40% and about 60%. This embodiment or another exemplary embodiment may provide for the adhesive to be a pressure sensitive adhesive applied at a weight between about 6 and about 20 gsm. This embodiment or another exemplary embodiment may provide for the adhesive to be a hot-melt adhesive and is applied at a weight between about 6 and about 40 gsm. This embodiment or another exemplary embodiment may provide for the adhesion of the adhesive to a rough substrate is between about 10% and about 50% greater at identical flood coat weights. This embodiment or another exemplary embodiment may provide for the deforming member is a roller having patterned surface etching. This embodiment or another exemplary embodiment may provide for the deforming member is a roller having a patterned surface attachment. This embodiment or another exemplary embodiment may provide for the deforming step takes place at a pressure between 5-150 PSI.

### BRIEF DESCRIPTION OF THE DRAWINGS

These, as well as other features, aspects, and advantages will be more completely understood and appreciated by referring to the following more detailed description of the presently preferred exemplary embodiments of the invention in conjunction with the accompanying drawings.

FIG. 1 is a side schematic view on an exemplary apparatus to effectuate patterning a liner.

FIG. 2a is a side plan view of an exemplary adhesive pattern in accordance with the disclosure.

FIG. 2b is an additional side plan view of another exemplary adhesive pattern in accordance with the disclosure.

FIG. 3 is a side perspective view of an exemplary spherical cap with respect to the disclosure.

FIG. 4 is a side view of an exemplary adhesive construction on a rough substrate in accordance with Example 1.

FIG. 5 is a side view of an exemplary adhesive construction in accordance with Example 2.

FIG. 6 is a side view of an exemplary adhesive construction in accordance with Example 4.

Unless otherwise indicated, the illustrations in the above figures are not necessarily drawn to scale.

### Definitions

As used herein, “regular pattern” means the evenness, consistency, and/or balance in shape, arrangement, and/or pattern orientation variation and homogeneity that is repeating.

As used herein, “irregular pattern” means not even or balanced in shape, arrangement, and/or pattern orientation variation and heterogeneity that is non-repeating.

As used herein, “repeat pattern” means the pattern of adhesive is regular in terms of shape, arrangement and/or pattern orientation and heterogeneity is repeating.

As used herein, “discontinuous” means that one or more regions, portions, parts, or spaces of the liner is not covered by adhesive.

As used herein, “continuous” means that all of one surface of the liner is covered by the adhesive at some level.

As used herein, “rough substrate” refers to any substrate with inconsistent surface level pattern that possesses known irregularities. For example, cardboard and kraft paper are two such substrates that are rough substrates. Roughness, depending on the source can be expressed by different metrics. For example, Ra is a roughness average or the arithmetic mean of the absolute values of the roughness profile. While Rz is a mean roughness depth as the arithmetic mean value of the single roughness depth.

As used herein, the expression “substantially uniform” means, with respect to the adhesive pattern, that the pattern has fewer than 2% of the area of the applied adhesive pattern having defects with respect to the total area of the applied adhesive pattern, preferably fewer than 1% of the area of the applied adhesive pattern having defects with respect to the total area of the applied adhesive pattern.

As used herein, the term “defect” means, with respect to the adhesive pattern, substantial deformity in the adhesive pattern that differs from the desired shape resulting in poor adhesion. For example, if the adhesive is deposited in a standard height and width, any deviation of this in either direction may be considered a defect.

As used herein, the term “multilayer” means, with respect to laminate construction, the adhesive coated face material with one or more additional layers. Non-limiting examples of such layers to make up the multilayer include protective layers, spacing layers, adhesive layers, optical component-containing layers, metallic layers, barrier layers, release liners, tie coat layers, clear layers, color layers, white layers, reflective layers, fluid transfer layers, strength promoting layers, topcoats, print receptive layers, print containing layers, indicia layers, functional layers, and the like as well as combinations thereof. The resultant multilayer laminate construction described herein can be used for a variety of applications including, but not limited to, graphics applications, such as automobile and architectural wraps; reflective applications, such as road and traffic signs, trains and other commercial vehicles, etc.; and label and packaging applications.

As used herein, first direction or along a vertical axis is defined as measured substantially perpendicular to the plane of a first side of the liner between a first side of a liner and a face stock. When measured, this refers to a height of a given component, for example, the height of an adhesive dot within the applied pattern.

As used herein, a horizontal axis is defined as measured substantially parallel to the plane of a first side of the liner between a first end and second end of the embossed liner. When measured, this refers to a width of a given component, for example, the width of the adhesive dot within the applied pattern.

As used herein, the term “coating” includes an array of deposition and/or material transfer techniques besides transfer coating. For example, the term coating includes direct coating, spraying, brushing, immersing, and other methods. These and other aspects are all described in greater detail herein.

As used herein, the term “super-adhesion” refers to adhesives performing better or equal to a flood coating of an identical adhesive at less coat weight than the flood coated adhesive.

As used herein, “gsm” means grams per square meter.

### DETAILED DESCRIPTION

### Adhesive Laminates/Adhesive Coated Face Materials

Adhesive region(s) and/or adhesive structures disposed on substrates are described herein. In some embodiments, the adhesive region(s) and/or structures exhibit particular dimensional proportions as described herein. In some embodiments, the adhesive is a pressure sensitive adhesive (PSA). The PSA can be applied using a variety of techniques, such as spraying, onto a face material, e.g., release liner or face stock. Once applied, the PSA may optionally be cured and/or otherwise processed. In some embodiments, the release liner and PSA deposited thereon are then contacted with a face material, such as label stock or a polymeric film, thereby at least partially transferring the PSA to the face material. The release liner may be removed at a later time to expose the PSA face and enable the user to adhere the face material to a substrate of interest. In other embodiments, the face stock (e.g., label stock or a polymeric film) and PSA deposited thereon are then contacted with a release liner. The release liner may be removed at a later time to expose the PSA face and enable the user to adhere the face material to a substrate of interest.

By use of these structures, assemblies, and/or techniques a variety of PSA properties and deposition configurations are now attainable, which were not possible before using conventional methods of depositing PSA onto face materials.

Adhesive laminates and/or adhesive coated face materials, particularly those produced using the methods described herein, and more specifically by roll to roll coating of adhesive onto a face layer of the laminate, are also described. Many of these laminates can be configured to provide one or more functions as detailed herein. It will however be understood that the present subject matter includes laminates as described herein, yet which may be produced by techniques other than the unique methods described herein.

### Adhesives

The laminates/constructs described herein contain one or more adhesives. The adhesive(s) can be a PSA, a non-pressure sensitive adhesive, a hot-melt adhesive, or combinations thereof. In some embodiments, the adhesive is a PSA. The PSA may be any known PSA. In some embodiments, the PSA is a solvent type adhesive, an emulsion type adhesive, or non-emulsion type adhesive. In some embodiments, the PSA is an emulsion adhesive. Hot melt PSAs may also be used. The adhesive may be acrylic or any other useful adhesive which has the hardness and adhesive properties needed for the laminates and/or adhesive coated facestocks. In certain embodiments, the adhesive should have a hardness sufficient to prevent the adhesive squeezing out of the laminate or article during processing.

Exemplary PSAs may be found in (1) Encyclopedia of Polymer Science and Engineering, Vol. 13, Wiley-Interscience Publishers (New York, 1988); (2) Polymer Science and Technology, Vol. 1, Interscience Publishers (New York, 1964); (3) those described in U.S. Pat. Nos. 5,164,444; 5,183,459; and 5,264,532, all issued to Bernard, and U.S. Pat. No. 5,385,965, issued to Bernard et al; and (4) combinations thereof. The PSAs may be a solvent based or may be a water based adhesive. Conventional PSAs, including acrylic-based PSAs, rubber-based PSAs and silicone-based PSAs may be used in the laminates/constructs described herein. In one embodiment, the pressure sensitive adhesive contains an acrylic emulsion adhesive.

In some embodiments, the pressure sensitive adhesive is prepared by polymerizing alkyl acrylates, vinyl esters, diesters of dicarboxylic acids and unsaturated acids. The alkyl acrylates typically contain from about 2 to about 12, or from about 4 to about 8 carbon atoms in the alkyl group. Examples of alkyl acrylates include, but are not limited to, ethyl, n-butyl, hexyl, 2-ethylhexyl, and isooctyl acrylates, with 2-ethylhexyl acrylate preferred. In one embodiment, the alkyl acrylates are present in an amount of at least about 35%. In some embodiments, the alkyl acrylates are present in an amount from about 35% to about 60% by weight.

The vinyl esters typically have from about 2 to about 12, or from about 4 to about 8 carbon atoms in the alkyl group. Examples of vinyl esters include, but are not limited to, vinyl acetate, vinyl propionate, vinyl butyrate, vinyl versatate and the like, with vinyl acetate being preferred. In some embodiments, the vinyl esters are present in an amount from about 15% to about 35% or from about 20% to about 25% by weight.

The diesters of the dicarboxylic acids include alkyl esters of unsaturated diacids, such as maleic acid or anhydride and fumaric acids. The alkyl group generally contains from about 2 to about 20, or from about 4 to about 16, or from about 6 to about 12 carbon atoms. Examples of diesters of diacids include, but are not limited to, butyl, octyl fumarate; hexyl, decyl maleate; di-2-ethylhexyl maleate; di-butyl fumarate; and di-2-ethylhexyl fumarate and mixtures thereof. In some embodiments, the diesters of diacids are present in an amount from about 20% to about 35% by weight.

The unsaturated acids generally contain from about 2 to about 12, or from about 2 to about 6 carbon atoms. Examples of the unsaturated acids include, but are not limited to, acrylic acid, methacrylic acid, itaconic acid, and the like. In some embodiments, the unsaturated acids are present in an amount up to 5% or from about 1% to about 3% by weight.

In exemplary embodiments, the coat weight may be between 4 and 60 gsm.

### Release Liners

In some embodiments, the laminates described herein may include one or more release liner(s). The liner may have a first side, a second side opposed to the first side, a first edge, and a second edge opposed to the second edge. The liner may be any useful liner which provides necessary support and release properties. The liner may be made of, or from, a variety of materials including, but not limited to, paper or polymer film liners. In one embodiment, the caliper of the paper is sufficient to die cut the resulting laminate or article. In one embodiment, the liner has lay flat properties. In some embodiments, the liner has a machine glaze or finish. In some embodiments, the liner has a silicone hold out layer. The hold out layer provides adhesion between the release coating and the release liner. The silicone holdout layer also prevents the silicone release coating from soaking into the liner.

In the instance of paper liners and other absorbent liners, these liners have a moisture content. The moisture content may be varied and changed in various ways in order to promote, prevent, or optimize patterning of the liner based on this moisture content. Additional discussion will be had with respect to the methods below.

In some embodiments, the release liner includes a liner having a release coating. The release coating of the release liner provides a releasable bond with the PSA or other adhesive. The release coating may be any composition which provides a desired releasable bond strength.

In one embodiment, the release coating is a silicone release coating. The release coating can be prepared by curing silicone polymers in the presence of a control release agent. In some embodiments, the control release agent is a copolymer of a monofunctional silicone unit of the formula R₃SiO_{1/2} and tetrafunctional silicone units SiO_{4/2} wherein R is an alkyl or alkenyl group. In one embodiment, the alkyl or alkenyl groups contain from about 1 to about 12, or from about 1 to about 6 carbon atoms. Non-limiting examples of alkyl and alkenyl groups include methyl, ethyl, propyl, butyl, hexyl, ethenyl, propenyl, butenyl and hexenyl groups.

The control release agent is typically reacted with a polysiloxane. The polysiloxane may be any polysiloxane which is useful in forming a release coating. Examples of useful polysiloxanes include, but are not limited to, vinyl terminated, hydroxy terminated and epoxy terminated polysiloxanes. In one embodiment, the polysiloxane is a functional polydialkyl siloxane, wherein the alkyl group contains from about 1 to about 6 carbon atoms. The alkyl groups independently include, but are not limited to, methyl, ethyl, propyl, butyl, pentyl, hexyl groups or mixtures thereof. In one embodiment, the alkyl or alkenyl group contains from 1 to about 12, or from 1 to about 6 carbon atoms. The polysiloxane typically has a viscosity average molecular weight of greater than 300,000 centipoise (cps). In another embodiment, the polysiloxane has a viscosity molecular weight from about 300,000 to about 1,000,000 or more. The polysiloxane may be represented by the formula (I):

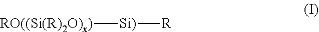

wherein each R is independently as defined above and x is an integer.

In some embodiments, the release coating is prepared with a cross linking agent. In some embodiments, the cross linking agent is a reactive polysiloxane, such as a polydialkyl or polyhydroalkyl siloxane. The alkyl groups are the same as those described above.

The release coating may be applied in a solvent, solvent-less or emulsion form. The release coating may be cured by any known curing process, e.g. thermal, radiation, etc., to form the release coating. The curing may be catalyzed by silicone soluble complexed compounds of Group VIII transition metals, such as platinum.

Commercially available release agents include, but are not limited to, GE SS-4335, a silicone release agent in unreactive solvent. Commercially available polysiloxanes include, but are not limited to, GE SS-4331, a vinyl terminated polydimethyl siloxane. Commercially available linking agents include, but are not limited to, GE SS-4300C, a polymethyvinyl siloxane. Exemplary catalysts include, but are not limited to, SS-8010 catalyst in toluene. These materials are available commercially from General Electric Company's Silicone Products Division. Similar silicone products are available under the tradename Syl-off from Dow Corning Corporation.

It will be understood that the present subject matter is not limited to any of the noted release coatings or agents, and instead includes nearly any release coating or agent suitable for the intended end use application. Furthermore, although the present subject matter has been described in association with release liners, it will be appreciated that appropriately configured carrier films and other members could be used instead of release liners.

### Face Material

Suitable face materials include, but are not limited to, synthetic papers such as polyolefin type and polystyrene type; various plastic films or sheets such as polyolefin, polyvinyl chloride, polyethylene terephthalate, polystyrene, polyurethane, polymethacrylate and polycarbonate. Additional examples of suitable face materials include paper and cardboard. The face material may be, or may include, a multilayer polymeric sheet. The multi-layers may be coextruded, or the multi-layers may be laminated together. In one embodiment, the face material includes both co-extruded multi-layers and laminated multi-layers. In addition, a white opaque film may be formed by adding a white pigment to one or more of the aforementioned synthetic resins and used as the face material. In one embodiment, a foamed film is used as the face material. The foamed film may be formed by a conventional foaming operation. In another embodiment, the face material may be a laminated body formed by combining a plurality of single layered sheets composed of the above listed materials. Examples of such a laminated body may include the combination of cellulose fiber paper with synthetic paper, and a laminated body of combined cellulose fiber paper with a plastic film or sheet. In another suitable embodiment, the face material includes coated and uncoated papers, metalized papers, aluminum foil, laminated paper and paper with a polymeric material extruded onto the surface of the paper. In certain versions, the face material can be coated with a liquid absorbent material. The selected face material may be porous or semi-porous. The face material may exhibit certain visibility characteristics such as opaqueness, color, and/or brightness. The face material may include water or other liquid absorbency properties. The face material may be electrically conductive and/or include electrically conductive coatings or regions. A wide array of commercially available face materials can be used such as for example those available under the designation TESLIN.

The thickness of the face material is optionally determined with reference to application specific criteria. Such criteria may include the desired end use. In one embodiment, the sheet thickness is in a range of from about 10 μm to about 300 μm. In another embodiment, the sheet thickness is in a range of from about 20 μm to about 200 μm. In still another embodiment, the sheet thickness is in a range of from about 30 μm to about 150 μm. Optionally, a primer treatment or a corona discharging treatment or a plasma treatment may be used on the face material to increase a bonding strength between the face material and a dried topcoat composition to be formed on a surface of the face material.

In certain embodiments described herein, the face material exhibits one or more functions or functional characteristics. For example, the face material may be selected to enable or promote an indication such as a visual indication of a liquid, outgassing such as directing or allowing flow of air or gas across a thickness of the face material, water or liquid retention within the face material, electrical discharge or conductivity of the face material, chemical delivery across a thickness of the face material, passage of sound across a thickness of the face material, and/or combinations of these functions or characteristics.

### Optional Layers

The adhesive coated face material and/or laminates described herein can include one or more additional layers or components. Non-limiting examples of such layers include protective layers, tie coat layers, clear layers, color layers, white layers, reflective layers, fluid transfer layers, strength promoting layers, topcoats, print receptive layers, print containing layers, indicia layers, functional layers, and the like.

### Laminate Properties

The laminates described herein may have specific and useful properties or functionalities. In some embodiments, the techniques described herein enable formation of laminates in which transfer, propagation, and/or migration of liquid, gas, sound waves, electrical current, and/or other agents or elements can occur and is controlled across or through the laminate in a Z-direction. The reference to “Z-direction” as made herein refers to a direction across a thickness dimension of a laminate or portion thereof, and thus references to “X-direction” and/or “Y-direction” refer to directions perpendicular to the Z-direction and correspond to width and length dimensions of the laminate.

Non-limiting representative examples of laminates having certain functionalities which are provided by the present subject matter include liquid indicator laminates, outgassing laminates, water absorbent laminates, sound channeling laminates, electrically conductive laminates, and laminates having combinations of these functionalities and/or laminates having combinations of one or more of these functionalities and additional functionalities.

For example, a liquid indicator laminate can be produced such that the speed of the indicator color change is linked to the facestock selection and porous adhesive properties. A discontinuous structure, such as resulting from pores in the adhesive layer or region(s), can allow, for example, liquid to channel through the discontinuous adhesive from one side of the adhesive to the other side and create a permanent discoloration when a dye or other agent in a functional coating in the laminate is dissolved.

In one embodiment, a liquid indicator laminate is provided. The speed or rate of the indicator color change is linked to the facestock properties such as for example absorbency of liquid, and porosity of the pattern adhesive in the Z-direction. The indication typically is irreversible and can be measured by color change or by a simple visual comparison.

The discoloration of a face or region of the laminate can be measured and quantified by optical change, such as by CIE Lab or by a simple visual comparison. The discoloration can be permanent or nonpermanent. The discoloration can also be temporary and revert to an initial state after passage of a period of time. In some embodiments, the period of time is predetermined.

This phenomenon of transport through discontinuities in an adhesive in the Z-direction can be implemented in other label applications and particularly pressure sensitive adhesive labels, such as for example, labels for outgassing substrates such as by air channeling in the Z-direction, moist substrate labeling such as by liquid channeling in the Z-direction, electrical discharge in the Z-direction, chemical delivery from one layer to another in the Z-direction, and/or sound channeling in the Z-direction. This phenomenon enables passage, transfer, and/or migration of a medium or agent from one side of an adhesive region of a laminate, to another side of the adhesive region. Although medium penetration or transport is noted as being in the Z-direction, it will be understood that the present subject matter is not limited to such and may also include penetration/transport in the X-direction and/or Y-direction.

In some embodiments, the laminates described herein include a layer or region of a secondary adhesive. The secondary adhesive is typically utilized to adhere the laminate to a substrate of interest. The secondary adhesive may contain one or more adhesives which are the same or different than the adhesive of the patterned or porous adhesive. Description of representative examples of secondary adhesives are provided herein. In such an adhesive configuration, the primary adhesive may be coated onto the facestock, the secondary adhesive may be coated onto the release liner, and the coated adhesive and release liner may be laminated together such that the primary and secondary adhesives are in direct contact with each other. Alternatively, or additionally, both the primary and secondary adhesive may be coated on the facestock or the release liner, then laminated together. It is contemplated that the layering of the primary and secondary adhesive relative to the facestock and the release liner may be either facestock, primary adhesive, secondary adhesive, and release liner or facestock, secondary adhesive, primary adhesive, release liner. Regardless of the order of primary and secondary adhesive, it is contemplated that at least one of the primary and secondary adhesive is patterned, taking into consideration that the other adhesive may be continuous.

In some embodiments, an array of different arrangements of layers and components may be utilized. In some embodiments using the patterned adhesive, e.g., the layer of discontinuous adhesive, that layer is disposed between a functional facestock and a liner or functional layer. And in the liquid indicator laminates, the patterned adhesive may be disposed between the functional facestock and the layer or region of functional agent that is sensitive to liquid passing through the laminate. And, in the liquid indicator laminates, the layer or region of the functional agent may be disposed between the patterned adhesive and the carrier layer.

Utilization of the techniques and features described herein enable production of adhesive laminates and/or adhesive coated face materials with fluid/air management characteristics, controlled removability, and/or unique thermal and/or electrical conductivity. In addition, use of these techniques and features enable reductions in materials, e.g., adhesives, and thus enable cost savings. However, it will be understood that the present subject matter includes the adhesive coated face materials and laminates described herein which are formed by other methods than the methods described herein.

The methods of the present subject matter can be performed in a batch, continuous, or semi-continuous fashion. For continuous methods, typical processing speeds range from about 100 m/min to 1,000 m/min. However, it will be understood that the present subject matter is not limited to these speeds and includes processing speeds less than 100 m/min and/or speeds greater than 1,000 m/min.

### Methods

Having discussed various components of the system, exemplary methods and methodologies of operation will be discussed.

### Patterning of Liner Materials and Adhesives

The inventors have discovered that through patterning the liner of the laminated material, super-adhesion is promoted for rough substrates.

Generally speaking, the Johnson-Kendall-Roberts peel model (“JKR”) provides a framework for understanding microscopic peel relative to angle. Specifically, these can be models by equation II:

$$G = \frac{F}{b} \cdot ( 1 - cos θ ) + {( \frac{F}{b} )}^{2} \cdot \frac{1}{2 \cdot E \cdot h} \qquad ( II )$$

This equation helps to describe the non-linear relationship between peel force F vs. peel angle θ, given certain backing modulus E, and fracture energy G. Average peel force is greater than the case in which the peel angle is kept at 90 degrees constant as the cosine of 90 degrees is zero, thus maximizing the term of 1-cos Θ. As one can see, varying this angle will have a significant impact on adhesion. Meanwhile, the peak peel force may be considered as the effective peel force instead of average. Where b may be a width parameter of the object. However, the force required to peel, for rough substrates can be enhanced if fibrillation is able to be maximized. Thus, formation and growth of fibrils during debonding is critical to the peel strength and the tack of adhesives.

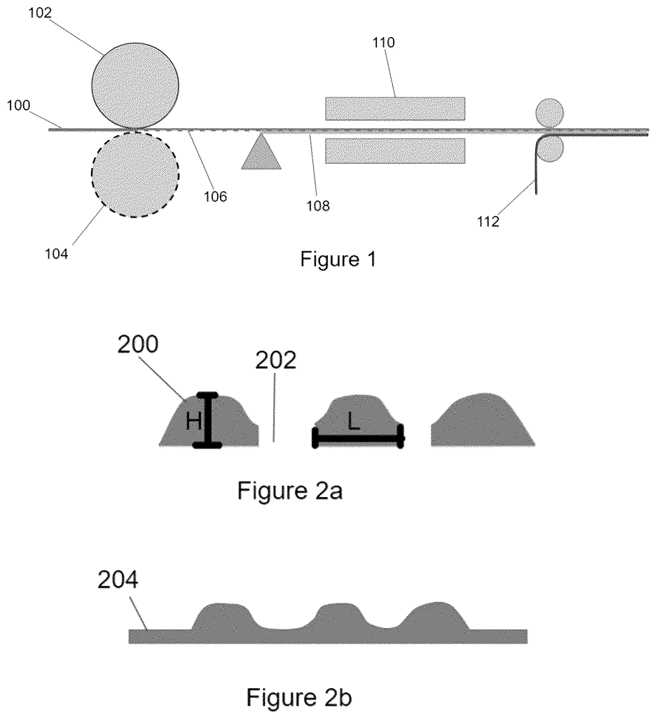

Fibrils can be maximized through two vectors for rough surfaces. First, patterning of the liner material can be done. This patterning of the liner material is done in order to increase the surface area of an adhesive that will be later applied to the liner material. Patterned structures favor fibrillation. Additionally, the adhesive itself may also be patterned. As a result of dual patterning additional fibrillation occurs resulting in more energy dissipation and a higher peel force required to break the adhesion. By means of illustration, FIG. 1 discusses this general process for patterning liners.

As can be seen in FIG. 1, an exemplary process to pattern an exemplary liner is shown. First, a pre-siliconized liner 100, is passed through a patterned mechanism 102 and a pressure roller 104. The patterned mechanism 102 may be patterned in a variety of ways. This may include, but is not limited to using teflon dots, a steel mesh pattern, an engraved roll, a sleeve on the outside of the patterned mechanism or other such methods known in the art to deform a liner. The result is a patterned liner 106. The pressures that the liner faces is in between 5-150 PSI. In exemplary embodiments the working cylinder pressure (which resulted in good embossing) was in the range of about 20 and about 120 psi. In this embodiment, the corresponding estimated line pressure is about 50 to about 400 pli and the actual nip pressure is greater than 300 psi.

After the liner has been deformed, to create a patterned liner 106, an adhesive 108 is applied to the patterned liner. In the exemplary embodiment, the adhesive 108 is applied by any known method in the art, including but not limited to, spray, printing, gravure, and additional methods.

After the adhesive 108 is applied, the patterned liner 106 and patterned adhesive 108 can be subject to an optional moisture modification unit 110. Depending on the properties of the pre-siliconized liner 100 and subsequent patterned liner 106, this step may occur prior to addition of the adhesive 108, the moisture modification unit 110 would therefore be prior to the patterning of the liner. In some embodiments the moisture modification could be steam foils, ovens, a liquid water applicator or other such solutions known in the art. The pre-siliconized liner 100 may be desired to be more or less malleable to deformation and this can be modulated by its moisture content. In exemplary embodiments, moisture content may be between 2-10%

After adhesive 108 coating or drying 110, a facestock 112 may be laminated to the adhesive 108 thereby creating an exemplary laminate of an embossed liner 104, patterned adhesive 108 and the facestock 112. This is merely exemplary and may have additional layers as discussed above and not repeated for the purposes of brevity. Through the application of the facestock 112, the embossed liner 104 with a patterned adhesive 108 is protected and is able to be transported and manipulated without the pattern deforming.

The adhesive could be patterned in a multitude of ways. Specifically, referring to FIG. 2A, an exemplary embodiment of 2D adhesive application pattern is shown. In this pattern there are peaks of adhesive 200 with space 202 between said peaks. While shown for the purposes of clarity and understanding, these peaks are merely exemplary and any shape including a given height (H) or width (W) which is shown is not necessarily to scale and is shown to gather an understanding of the exemplary embodiments. This exemplary pattern may occur as a regular pattern, allowing for evenness, consistency, and/or balance in shape, arrangement, and/or pattern orientation variation and homogeneity that is repeating across the whole embossed liner. As seen in this embodiment, the exemplary pattern may be a repeat pattern where the adhesive is regular in terms of shape, arrangement and/or pattern orientation and heterogeneity is repeating. This exemplary embodiment is a discontinuous pattern, in that one or more regions, portions, parts, or spaces of the liner is not covered by adhesive. Alternatively, in this or other embodiments, the exemplary pattern may an irregular pattern, or not even or balanced in shape, arrangement, and/or pattern orientation variation and heterogeneity that is non-repeating. In embodiments where the adhesive is in a regular discontinuous adhesive pattern, coat weights may range from 3 gsm to 40 gsm.

Referring now to FIG. 2B, an alternative embodiment of an adhesive pattern in shown. In this embodiment there is a minimum layer of flood coated, or continuous coating where all of one surface of the liner is covered by the adhesive at some level. Then, peaks of the adhesive 200 may be overlaid on top of the flood coated adhesive 204. This exemplary pattern may occur as a regular pattern, allowing for evenness, consistency, and/or balance in shape, arrangement, and/or pattern orientation variation and homogeneity that is repeating across the whole embossed liner. As seen in this embodiment, the exemplary pattern may be a repeat pattern where the adhesive is regular in terms of shape, arrangement and/or pattern orientation and heterogeneity is repeating. Alternatively, in this or other embodiments, the exemplary pattern may an irregular pattern, or not even or balanced in shape, arrangement, and/or pattern orientation variation and heterogeneity that is non-repeating. In embodiments where the adhesive is in a regular continuous adhesive pattern, coat weights of the continuous flood coated portion may be in the range of about 0.5 to about 8 gsm. This embodiment or another allow for the percentage of the adhesive coatweight in continuous flood to be between 0 and about 70% of the total adhesive.

The adhesive can be applied using techniques known in the art. For example, in some embodiments, the adhesive is applied to the tensioned, temporarily deformed substrate or web using a slot die. The thickness of the coating can be controlled, for example by metering using a metering pump, or by other techniques known in the art. The die body can include a manifold to uniformly distribute the flow of adhesive across the slot width. The appearance of the adhesive layer on the liner or web depends on the coating gap or coating angle between the die body and the roller. In some embodiments, coating may be achieved through electrifying one or more of the substrate of which the coating is to be applied and the adhesive itself. In another embodiment, this coating may be done through electrostatic deposition.

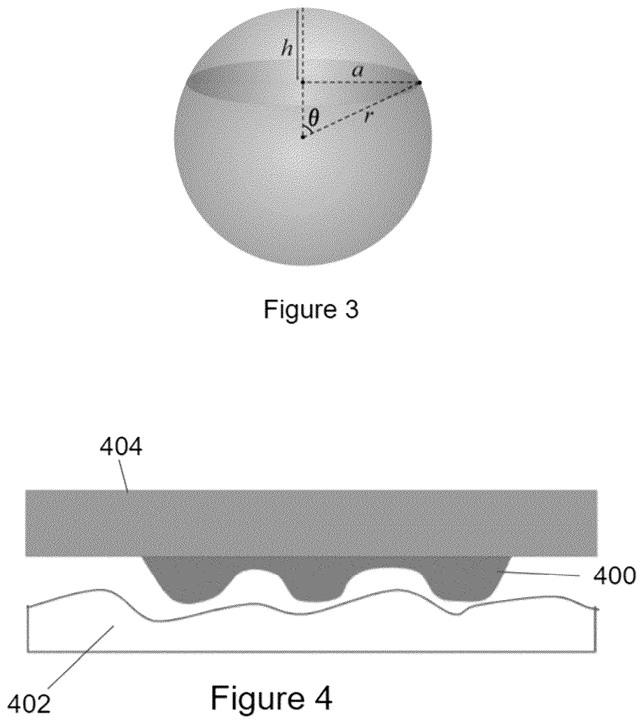

For the sake of clarity, the patterned adhesives are assumed to be a spherical cap in any sort of packing arrangement, given a certain footprint area of coverage. Referring to FIG. 3, this is illustrated. In this figure, it can be seen that there is a “cap” portion of the sphere with a height “h”, a radial width or a cap radius of “a”, a radius “r” and an angle “Θ”. The adhesive feature area (V_{cap}) may be expressed by the formula (III):

$${V}_{cap} = \frac{1}{6} π h ( 3 {a}^{2} + {h}^{2} ) \qquad ( III )$$

This can be compared to the coatweight (c in μm) of a liner where K is the dot footprint area coverage of a liner for flood coated (V_{flood}) as expressed by formula (IV):

$${V}_{flood} = \frac{π {a}^{2}}{K} \text{?} \qquad ( IV )$$

$$\text{?} \text{indicates text missing or illegible when filed}$$

In an exemplary embodiment, the applied patterned adhesive has a peak height (h) and a width (a+a or 2a) and the ratio between the peak height to the width is between about 0.02 and about 0.05. In this embodiment or another exemplary embodiment, the average height is in the range of about 20 μm to about 40 μm. In this embodiment or another exemplary embodiment, the average width is in the range of 0.4 mm to about 2.0 mm. Additionally, the coverage of the applied patterned adhesives is between about 40 and about 60% of the liner.

### EXAMPLES

All Examples were produced by contacting the first side of the liner with a deforming member to deform the liner at least temporarily through contact with the deforming member; and substantially simultaneously when the liner is at least temporarily deformed applying an adhesive in a manner that is substantially uniform to at least a portion of the first side of the liner but less than an entirety of the first side of the liner while the liner is temporarily deformed forming a pattern of adhesive. Comparative Examples were flood coated with adhesive rather than pattern coated.

### Examples 1, 2, and 3 with Comparative Example A

Four different samples were prepared, each using Fasson® S692N (available from Avery Dennison Corporation in Mentor, OH) as its adhesive. Fasson® S692N is a clear general purpose permanent acrylic adhesive which exhibits a balance of high cohesive strength and adhesion to low surface-energy substrates for lasting performance on squeezable containers and is specifically designed to exhibit excellent wetout characteristics and short-term removability.

The construction of Example 1 can be seen in FIG. 4. Example 1 was carried out where the adhesive 400 was facing a rough substrate 402 on a patterned liner 404 (not shown as patterned for sake of clarity here). As discussed above, the adhesion on a rough surface will be even greater due to the additional factor of peak to peak contact, that is the thicker regions of adhesive have greater probability of interacting with higher features on the surface. Thus, enhanced fibrillation is merely consequence of higher thickness of the adhesive at that location. The facestock was 1 mil clear PET as the adhesive was coated using a patterned siliconized liner. Example 1 was then coated at different coat weights, 10 gsm, 15 gsm, and 20 gsm on the glossy side.

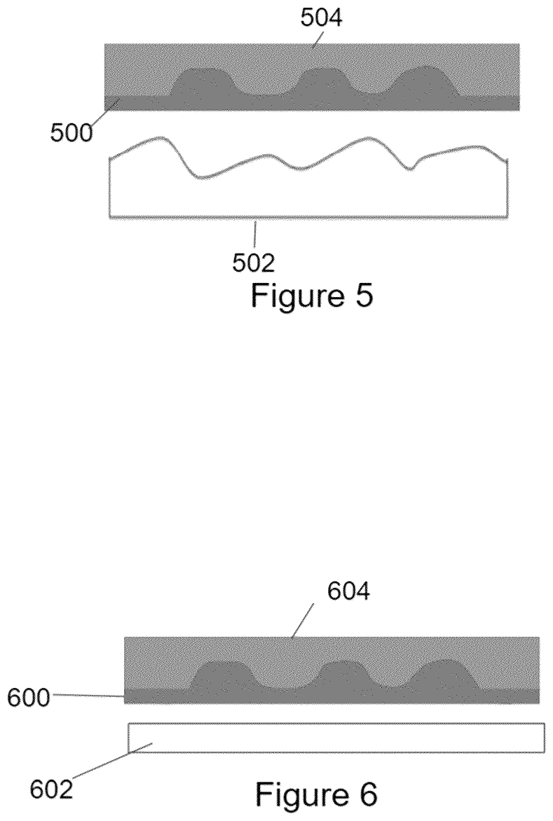

FIG. 5 illustrates Example 2. Example 2 was carried out where the facestock was patterned in a manner to match the patterned adhesive. The face was 2 mil BG40 white, a supercalendered glassine paper (available from Avery Dennison Corporation in Mentor, OH) where the adhesive was coated directly on the matte side of the patterned BG40. The adhesive is in contact with a rough substrate. Example 2 was then coated at different coat weights, 10 gsm, 15 gsm, and 20 gsm.

Example 3 was carried out where the facestock was patterned in a manner to match the patterned adhesive. The face was 2 mil BG40 white, a supercalendered glassine paper (available from Avery Dennison Corporation in Mentor, OH) where the adhesive was coated directly on the siliconized side of the patterned BG40. The adhesive is in contact with a rough substrate. Example 3 was then coated at different coat weights, 10 gsm, 15 gsm, and 20 gsm.

Comparative Example A was 1 mil clear PET with the identical adhesive as flood coated on a rough substrate. Example A was then coated at different coat weights, 10 gsm, 15 gsm and 20 gsm.

The coat weights and the relevant 90-degree peel adhesion test from cardboard (rough substrate) with 20 minutes of dwell time at room temperature are all summarized in Table 1 below:

TABLE 1

| Peel Value at Coatweight | 1 | 2 | 3 | A |
|---|---|---|---|---|
| 10 | 2.2 | 0.9 | 0.7 | 1 |
| 15 | 3.3 | 1.7 | 1.7 | 1.8 |
| 20 | 5.8 | 1.9 | 2 | 3.7 |

All coatweights are in gsm and all peel values are in N/in.

As can be seen, the peel values of Example 1 are 1.2 N/in greater than Comparative Example A flood coated at 10 gsm, 1.5 N/in greater than Comparative Example A flood coated at 15 gsm, and 2.1 N/in greater than Comparative Example A flood coated at 20 gsm. This demonstrates for the adhesion of the adhesive to a rough substrate when pattern coated and patterned lined is can be improved by up to about 55% at identical flood coat weights. The contact of the pattern of adhesive with a rough substrate leads to enhanced adhesion on the rough substrate with less adhesive than a continuous uniform flood coat.

### Example 4 and 5 with Comparative Example B

Three different samples were prepared, each using Fasson® S692N (available from Avery Dennison Corporation in Mentor, OH) as its adhesive as discussed above.

FIG. 6 illustrates Example 4. Example 4 was carried out was carried out where the facestock 604 was patterned in a manner to match the patterned adhesive 600. The face was 2 mil BG40 white, a supercalendered glassine paper (available from Avery Dennison Corporation in Mentor, OH) where the adhesive was coated directly on the matte side of the patterned BG40. The adhesive is in contact with a smooth substrate 602. Example 4 was then coated at different coat weights, 10 gsm, 15 gsm, and 20 gsm. Example 5 is the same except the adhesive was coated on the siliconized side of the patterned facestock at different coat weights of 10 gsm, 15 gsm, and 20 gsm.

Comparative Example B was 1 mil clear PET with the identical adhesive as flood coated on a smooth substrate. Example B was then coated at different coat weights, 10 gsm, 15 gsm, and 20 gsm.

The coat weights and the relevant 90-degree peel adhesion test from cardboard (rough substrate) with 20 minutes of dwell time at room temperature are all summarized in Table 2 below:

TABLE 2

| Peel Value at Coatweight | 4 | 5 | B |
|---|---|---|---|
| 10 | 2.2 | 1.9 | 4.8 |
| 15 | 3.4 | 4.6 | 7.1 |
| 20 | 5.5 | 5.6 | 8.2 |

All coatweights are in gsm and all peel values are in N/in.

As can be seen, the peel values of Example 4 and 5 are less than Comparative Example B flood coated at 10 gsm, 15 gsm, and 20 gsm. This demonstrates for the adhesion of the adhesive to a smooth substrate when pattern coated and patterned lined is not improved at identical flood coat weights.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method for patterning an adhesive layer comprising:
providing a liner having a first side, a second side, a first edge, and a second edge;
contacting the first side of the liner with a deforming member to deform the liner at least temporarily through contact with the deforming member; and
substantially simultaneously when the liner is at least temporarily deformed applying an adhesive in a manner that is substantially uniform to at least a portion of the first side of the liner but less than an entirety of the first side of the liner while the liner is temporarily deformed forming a pattern of adhesive; and
whereby contact of the pattern of adhesive with a rough substrate leads to enhanced adhesion on the rough substrate with less adhesive than a continuous flood coat.

2. The method of claim 1, wherein the adhesive is applied in a discontinuous manner.

3. The method of claim 1, wherein the adhesive is applied in a continuous manner.

4. The method of claim 1, wherein the liner is a paper derived liner with a moisture content.

5. The method of claim 4, prior to contacting, further comprising:
adjusting the moisture content of the liner.

6. The method of claim 5, wherein adjusting the moisture content comprises:
adding moisture to the liner.

7. The method of claim 5, wherein adjusting the moisture content comprises:
removing moisture to the liner.

8. The method of claim 4, further comprising:
adjusting the moisture content of the liner after applying the adhesive.

9. The method of claim 1, wherein the liner comprises PET.

10. The method of claim 1, wherein at least a portion of the liner is siliconized.

11. The method of claim 1, further comprising:
laminating the liner with a facestock material.

12. The method of claim 1, wherein the applied adhesive has a peak height in the first direction and a peak width between the first edge and second edge and wherein the ratio between the peak height to the width is between about 0.02 and about 0.05.

13. The method of claim 12, wherein the average height is in the range of about 20 μm to about 40 μm.

14. The method of claim 12, wherein the average width is in the range of 0.4 mm to about 2.0 mm.

15. The method of claim 12, wherein the percentage of the first side of the liner covered by the peaks of the adhesive is between about 40% and about 60%.

16. The method of claim 1, wherein the adhesive is a pressure sensitive adhesive or a hot melt adhesive applied at a weight between about 6 and about 20 gsm.

17. The method of claim 1, wherein the adhesion of the adhesive to a rough substrate is between about 10% and about 50% greater at identical flood coat weights.

18. The method of claim 1, wherein the deforming member is a roller having patterned surface etching.

19. The method of claim 1, wherein the deforming member is a roller having a patterned surface attachment.

20. The method of claim 1, wherein the deforming step takes place at a pressure between about 5 and about 150 PSI.
